(19) United States
(12) Patent Application Publication
(10) Pub. No.: US 2007/0188136 A1
(43) Pub. Date: Aug. 16, 2007

(54) BATTERY CHARGING

(75) Inventor: Jang Geun Oh, Suwon City (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/621,302

(22) Filed: Jan. 9, 2007

(30) Foreign Application Priority Data
Feb. 3, 2006 (KR) 2006-0010740

(51) Int. Cl. H02J 7/00

(52) U.S. Cl. 320/115

(57) ABSTRACT

A battery charge control apparatus includes a memory unit that stores charge termination currents that correspond to a plurality of charge modes, respectively. A control unit receives a designed capacity (full charge capacity) of a battery and an actual charge capacity thereof from a battery pack through a smart bus, and confirms whether the battery is currently in a full charge state. If it is confirmed that the battery is not in the full charge state, the control unit sends a charge unit a charge initiation control signal for controlling initiation of battery charging. Further, if a charge mode is designated, the control unit reads a charge termination current corresponding to the designated charge mode from the memory unit. Moreover, the control unit detects a charge voltage, i.e., a voltage difference ΔV between both ends of a resistor R connected between a power supply and the battery pack, and calculates a charge current I using the detected voltage V and the resistance of resistor R. If the calculated charge current is equal to or less than the charge termination current that has been read from the memory unit, the control unit determines that the battery is in the full charge state, and sends the charge unit a charge termination control signal for controlling termination of the battery charging. When the charge unit receives the charge initiation control signal from the control unit, the charge unit performs control such that a switch is closed to initiate supply of power to the battery pack. On the other hand, when the charge unit receives the charge termination control signal from the control unit, the charge unit performs control such that the switch is open to terminate supply of power to the battery pack. A single charger can support a plurality of charge modes, resulting in more effective and improved effects.

### BACKGROUND

1. Technical Field

This disclosure relates to a battery charger and a method of charging a battery which are capable of supporting a plurality of charge modes.

2. Description of the Related Art

Conventional battery chargers charge batteries in one of a plurality of charge modes, depending on chemical properties of batteries, e.g., Li-ion, Ni-MH, Ni—Cd, and the like.

In particular, if a battery has chemical properties of Li-ion, the charger may charge the battery in one of two charge modes: a fast charge mode (quick charge mode or pulse charge mode) and a normal charge mode (constant-current and constant-voltage charge mode).

The fast charge mode and the normal charge mode should satisfy different charge termination currents as shown in the table of FIG. 1. The conventional charger is operated in one of the two charge modes. However, since the charger is designed such that its charge termination current is set to only one value upon manufacture thereof, the charger substantially supports only a single charge mode.

FIG. 2 illustrates examples of a charge voltage curve and a charge current curve of a battery. The charge current of the battery exhibits a constant current in a charge time interval of 0 to T1 and gradually decreases in a charge time interval of T1 to T2. An actual charge capacity reaches a designed capacity (full charge capacity) at a charge time of T2, so that the charge may be terminated.

However, if a battery is charged in a normal charge mode using a charger of which a charge termination current is set in a fast charge mode (300 mA or more), a charge operation is terminated at a charge time of T3, as shown in FIG. 2, where the charge termination current is 300 mA. As a result, there is a problem in that an actual charge capacity may be lower than a designed capacity (full charge capacity) of the battery.

### SUMMARY

In one general aspect, a battery charger includes a charge unit configured to provide a charge current to a battery, and a control unit configured to control operation of the charge unit according to a charge mode, wherein the charge mode is selected from among a plurality of charge modes. The battery charger may further include a memory unit configured to store values of charge termination currents for the charge modes. The charge modes may include a fast charge mode and a normal charge mode. Also, the battery charger may further include a charge current detection unit configured to provide the control unit with a value of the charge current to the battery. The charge current detection unit may include a resistor connected between a power supply and the battery. In order to control the operation of the charge unit, the control unit may compare the value of the charge current with one of the values of the charge termination currents stored in the memory unit which corresponds to the selected charge mode. For example, the control unit may be configured to terminate charging of the battery if the value of the charge current is lower than or equal to the charge termination current value which corresponds to the selected charge mode.

In another general aspect, a notebook computer having the above battery charger is provided.

In another general aspect, a method of charging a battery includes selecting a charge mode among a plurality of charge modes, and charging the battery according to the selected charge mode. The method may further include storing values of charge termination currents for the charge modes, and detecting a value of a charge current to the battery. The detected value may be compared with one of the stored values of the charge termination currents which corresponds to the selected charge mode. The charge may be terminated if the detected charge current value is lower than or equal to the stored value.

In another general aspect, a battery charge control apparatus and method may be configured to enable a single charger to support a plurality of charge modes by performing control based on a charge termination current which may be variably set depending on a charge mode.

To this end, a battery charge control apparatus includes a battery to be charged by receiving electric power, and a control unit performing control such that battery charging is initiated if a charge mode is designated among a plurality of charge modes, and such that the battery charging is terminated in response to the designated charge mode.

The apparatus may further include a memory unit for storing charge termination currents corresponding to the charge modes. The control unit may include a reading unit for reading a charge termination current corresponding to the designated charge mode from the memory unit, a calculation unit for calculating a charge current of the battery for which the charging has been initiated, and a comparison unit for comparing the calculated charge current with the read charge termination current. The control unit may perform control such that the charging is terminated based on the comparison results.

The calculation unit may include a voltage detection unit for detecting a charge voltage of the battery, and the calculation unit may calculate the charge current using the detected charge voltage.

If the comparison results show that the charge current is equal to or less than the charge termination current, the control unit may perform control such that the charging is terminated.

If the battery has chemical properties of Li-ion, the charge modes may include a fast charge mode (quick charge mode or pulse charge mode) and a normal charge mode (constant-current and constant-voltage charge mode).

The charge termination current may be equal to or larger than 300 mA if the designated charge mode is the fast charge mode (quick charge mode or pulse charge mode), and the charge termination current may be equal to or less than 200 mA if the designated charge mode is the normal charge mode (constant-current and constant-voltage charge mode).

In another general aspect, a battery charge control method includes a first step of confirming whether a charge mode is designated among a plurality of charge modes, a second step of, if it is confirmed that a charge mode is designated, performing control such that battery charging is initiated, and a third step of performing control such that the charging is terminated in response to the designated charge mode.

The third step may include a first sub-step of reading a charge termination current corresponding to the designated charge mode among charge termination currents respectively corresponding to the plurality of charge modes, a second sub-step of calculating a charge current of the battery for which the charging has been initiated, a third sub-step of comparing the calculated charge current with the read charge termination current, and a fourth sub-step of performing control such that the charging is terminated depending on the comparison results.

The second sub-step may include a voltage detection step of detecting the charge voltage of the battery, and a current calculating step of calculating the charge current using the detected charge voltage.

The fourth sub-step may include performing control such that the charging is terminated if the comparison results show that the charge current is equal to or less than the charge termination current.

If the battery has chemical properties of Li-ion, the plurality of charge modes may include a fast charge mode (quick charge mode or pulse charge mode) and a normal charge mode (constant-current and constant-voltage charge mode).

The charge termination current may be equal to or larger than 300 mA if the designated charge mode is the fast charge mode (quick charge mode or pulse charge mode), and the charge termination current may be equal to or less than 200 mA if the designated charge mode is the normal charge mode (constant-current and constant-voltage charge mode).

In another general aspect, a portable computer having a battery charge apparatus is provided. The battery charge apparatus may include a battery that uses Li-ion and is charged by receiving electric power, and a control unit employing a fast charge mode or a normal charge mode depending on a user's selection, and performing control such that battery charging is terminated according to the employed charge mode.

In another general aspect, a portable computer has a battery that is charged by confirming whether a charge mode is designated among a plurality of charge modes, if it is confirmed that a charge mode is designated, performing control such that battery charging is initiated, and performing control such that the charging is terminated in response to the designated charge mode. The battery may be Li-ion, and the charge mode may be a fast charge mode or a normal charge mode.

The battery charge control apparatus and method as explained above may perform control such that a charge termination current is variably set depending on a charge mode, thereby supporting a plurality of charge modes.

Other features will be apparent from the following description, including the drawings, and the claims.

### BRIEF DESCRIPTION OF THE DRAWINGS

The above and other features and advantages will become apparent from the following descriptions given in conjunction with the accompanying drawings, in which:

FIG. 1 is a table showing charge termination currents of two charge modes for a battery having chemical properties of Li-ion;

FIG. 2 is a graph illustrating examples of a charge voltage curve and a charge current curve of a battery;

FIG. 3 is a block diagram of a battery charger; and

FIG. 4 is a flowchart of a method of charging a battery.

### DETAILED DESCRIPTION

Hereinafter, implementations of a battery charger and method are described in detail with reference to the accompanying drawings.

Although the implementations are described in connection with a battery having chemical properties of Li-ion, various modifications can be made, including implementations for other types of batteries.

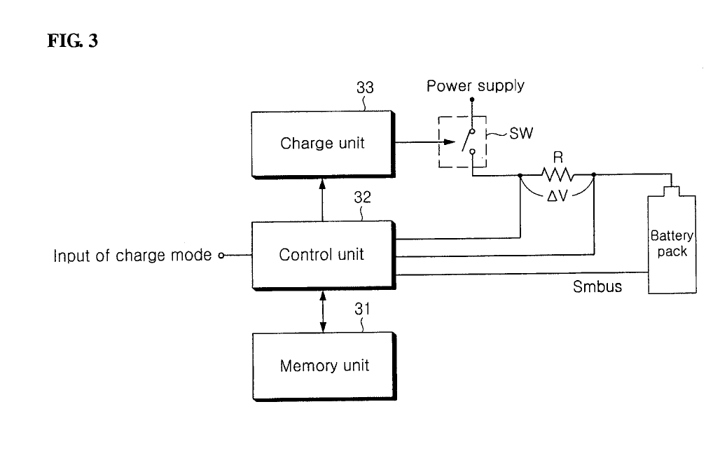

FIG. 3 is a block diagram of a battery charger that includes a charge unit 33 configured to provide a charge current to a battery, and a control unit 32 configured to control operation of the charge unit 33 according to a charge mode. The charge mode may be selected from among a plurality of charge modes.

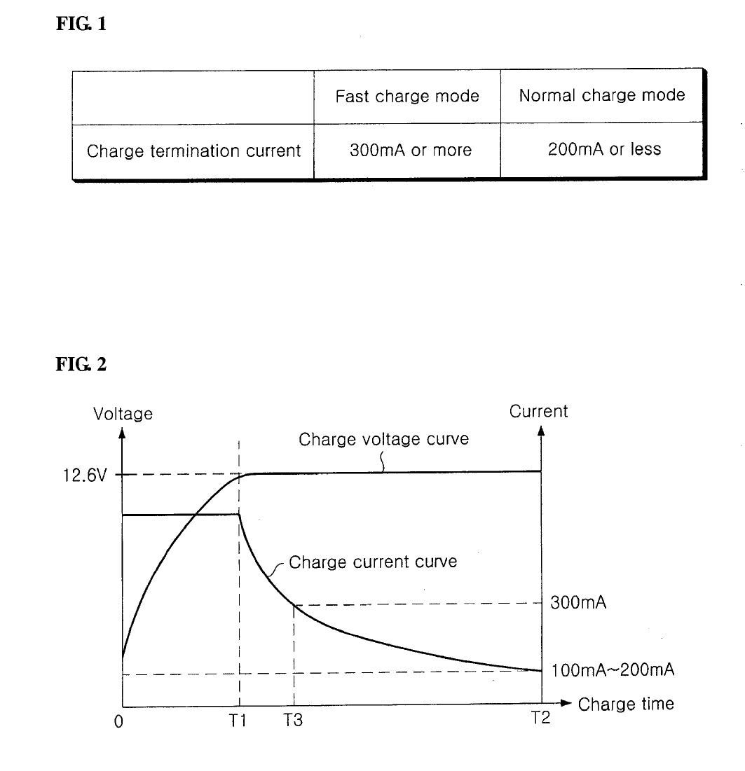

A memory unit 31 stores charge termination currents that correspond to the plurality of charge modes, respectively. As shown in FIG. 1, the charge termination current may be 300 mA or more in case of a fast charge mode, whereas it may be 200 mA or more in case of a normal charge mode. The charge termination currents may be set to other values within the aforementioned range based on manufacturing specifications.

The control unit 32 receives a designed capacity (full charge capacity) of a battery and an actual charge capacity thereof from a battery pack through a smart bus, and confirms whether the battery is currently in a full charge state. If it is confirmed that the battery is not in the full charge state, the control unit 32 sends the charge unit 33 a charge initiation control signal for controlling initiation of battery charging.

Further, if a charge mode is designated, the control unit 32 reads a charge termination current corresponding to the designated charge mode from the memory unit 31.

Moreover, a charge current detection unit may be adapted to provide the control unit 32 with a value of the charge current to the battery back. For example, the control unit 32 detects a charge voltage, i.e., a voltage difference ΔV between both ends of a resistor R which is connected between a power supply and the battery pack, and calculates a charge current I using the detected voltage V and the resistance of the resistor R. The charge current can be calculated as follows:

I (charge current)=V (voltage)/R.

If the calculated charge current is equal to or less than the charge termination current that has been read from the memory unit 31, the control unit 32 determines that the battery is in the full charge state, and sends the charge unit 33 a charge termination control signal for controlling termination of the battery charging.

When the charge unit 33 receives the charge initiation control signal from the control unit 32, the charge unit 33 performs control such that a switch is closed to initiate supply of power to the battery pack. On the other hand, when the charge unit 33 receives the charge termination control signal from the control unit 32, the charge unit 33 performs control such that the switch is open to terminate supply of power to the battery pack.

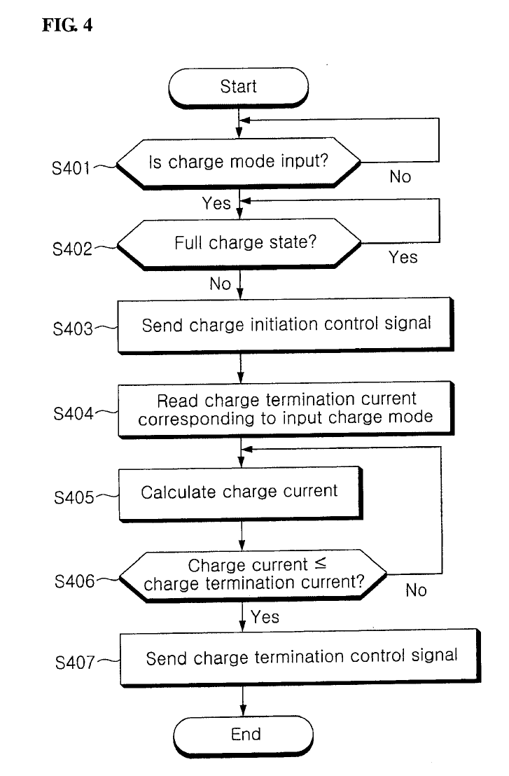

FIG. 4 is a flowchart of a method of charging a battery. Initially, a user selects a charge mode from among a plurality of charge modes, e.g., a fast charge mode and a normal charge mode, by using a basic input output system (BIOS) or a Windows program.

When the selected charge mode is inputted into the control unit 32 (Yes in step 401), the control unit 32 receives the designed capacity (full charge capacity) and actual charge capacity of the battery from the battery pack through the smart bus Smbus and confirms whether the battery is currently in the full charge state (S402). If it is confirmed that the battery is not in the full charge state (No in step 402), the control unit 32 sends the charge unit 33 the charge initiation control signal for controlling the initiation of the battery charging (S403).

Meanwhile, if the selected charge mode, which has been inputted in step S401, is the normal charge mode, the control unit 32 reads a charge termination current (e.g., 200 mA or less) corresponding to the received charge mode, i.e., the normal charge mode, from the memory unit 32 (S404).

Then, the control unit 32 detects the charge voltage, i.e., the voltage difference between the both ends of the resistor R connected between the power supply and the battery pack, and calculates the charge current I using the detected voltage V and the resistance of resistor R (S405).

If the calculated charge current is equal to or less than the charge termination current (Yes in step S406), the control unit 32 determines that the battery is in the full charge state, and sends the charge unit 33 the charge termination control signal for controlling the termination of the battery charging (S407).

If the calculated charge current is not less than the charge termination current (No in step S406), the control unit 32 returns to step S405 where the charge current of the battery being charged is calculated. Then, step S405 and step S406 where the calculated charge current is compared with the read charge termination current are repeated.

As described above, the battery charger and method perform control based on a charge termination current which may be variably set depending on a charge mode, whereby a single charger can support a plurality of charge modes, resulting in more effective and improved effects.

Other implementations are within the scope of the following claims.

What is claimed is:

1. A battery charger comprising:
a charge unit configured to provide a charge current to a battery; and
a control unit configured to control operation of the charge unit according to a charge mode, wherein the charge mode is selected among a plurality of charge modes.

2. The battery charger of claim 1, further comprising a memory unit configured to store values of charge termination currents for the plurality of charge modes.

3. The battery charger of claim 2, wherein the plurality of charge modes comprise a fast charge mode and a normal charge mode.

4. The battery charger of claim 2, wherein the charge mode is selected by a user among the plurality of charge modes.

5. The battery charger of claim 2, further comprising a charge current detection unit configured to provide the control unit with a value of the charge current to the battery.

6. The battery charger of claim 5, wherein the charge current detection unit comprises a resistor connected between a power supply and the battery.

7. The battery charger of claim 5, wherein the control unit is configured to control the operation of the charge unit by comparing the value of the charge current with one of the values of the charge termination currents stored in the memory unit.

8. The battery charger of claim 5, wherein the control unit is configured to compare the value of the charge current with one of the values of the charge termination currents which corresponds to the selected charge mode.

9. The battery charger of claim 8, wherein the control unit is configured to terminate charging of the battery if the value of the charge current is lower than or equal to the charge termination current value which corresponds to the selected charge mode.

10. A notebook computer comprising a battery charger as in any one of claims 1, 2, 5 and 7.

11. A method of charging a battery, comprising:
selecting a charge mode among a plurality of charge modes; and
charging the battery according to the selected charge mode.

12. The method of claim 11, further comprising storing values of charge termination currents for the plurality of charge modes.

13. The method of claim 12, further comprising detecting a value of a charge current to the battery.

14. The method of claim 13, further comprising comparing the detected charge current value with one of the stored values of the charge termination currents which corresponds to the selected charge mode.

15. The method of claim 14, further comprising terminating charging the battery if the detected charge current value is lower than or equal to the one of the stored values of the charge termination currents which corresponds to the selected charge mode.
